(19) United States
(12) Patent Application Publication
(10) Pub. No.: US 2023/0105780 A1
(43) Pub. Date: Apr. 6, 2023

(54) USER-EXPERIENCE BASED PROMOTIONAL STRATEGY

(71) Applicant: International Business Machines Corporation, Armonk, NY (US)

(72) Inventors: Joseph Lam, Markham (CA); Robert Paterson, High Wycombe (GB)

(21) Appl. No.: 17/449,832

(22) Filed: Oct. 4, 2021

(51) Int. Cl. G06Q 30/02; G06F 11/34; G06F 11/30

(52) U.S. Cl. CPC G06Q 30/0254; G06Q 30/0201; G06F 11/3438; G06F 11/3006; G06Q 30/0633

(57) ABSTRACT

Promotional materials are presented to a user according to user-experience as defined by certain parameter values detected during operation of a computing device. Operation of the computing device may include playing a video game. The operation of the computing device is monitored for non-conforming parameter values with respect to ideal parameter values. The promotional items disclosed in the promotional materials are identified as a way to improve the current user experience if added to the current computing system.

### BACKGROUND

The present invention relates generally to the field of products and service promotions, and more particularly to deploying promotional materials based on user experience.

Modern promotional strategies include an environmental element with respect to weather, history of user interaction and activity, user location, value and/or quality of promotional items, and logistics.

Computer performance refers to the amount of useful work accomplished by a computer system. Computer performance is often estimated in terms of accuracy, efficiency, and/or speed of executing computer program instructions. With regard to computer performance, one or more of the following factors might be involved: (i) response time for a given piece of work; (ii) throughput; (iii) utilization of computing resources; (iv) levels of data compression and decompression; (v) high availability of the computing system and/or application; (vi) bandwidth; and/or (vii) data transmission time.

### SUMMARY

In one aspect of the present invention, a method, a computer program product, and a system includes: (i) monitoring a computing activity of a user for a set of performance parameters associated with user-experience during performance of the computing activity; (ii) responsive to a performance parameter value not conforming to a corresponding target parameter value, determining a set of computer components effecting the performance parameter value; (iii) identifying promotional material for modifying the set of computer components; and (iv) presenting to the user the promotional material.

In another aspect of the present invention, a method, a computer program product, and a system includes: (i) identifying the performance parameter value while monitoring the set of performance parameters; (ii) comparing the performance parameter value to a target performance parameter corresponding to the performance parameter of the set of performance parameters; and (iii) determining the performance parameter value does not conform to a threshold value of the target performance parameter.

In yet another aspect of the present invention, a method, a computer program product, and a system includes analyzing performance data to identify a promotional item to change the set of computer components to a second set of computer components including the promotional item. The including the promotional item is pre-defined as resulting in an acceptable user experience while performing the computing activity.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a schematic view of a second embodiment of a system and method according to the present invention.

### DETAILED DESCRIPTION

Promotional materials are presented to a user according to user-experience as defined by certain parameter values detected during operation of a computing device. Operation of the computing device may include playing a video game. The operation of the computing device is monitored for non-conforming parameter values with respect to ideal parameter values. The promotional items disclosed in the promotional materials are identified as a way to improve the current user experience if added to the current computing system. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

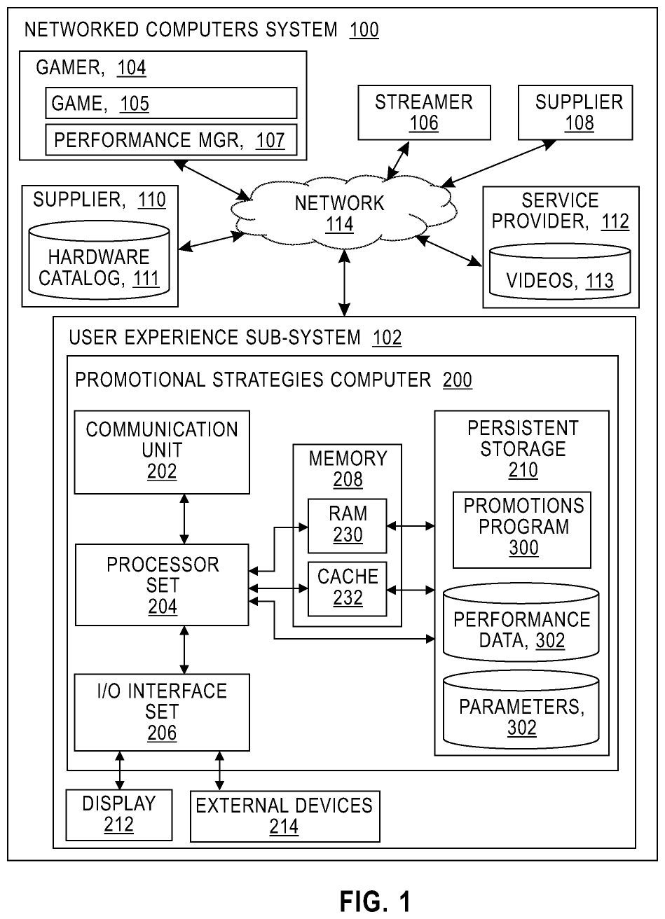

The present invention will now be described in detail with reference to the Figures. FIG. 1 is a functional block diagram illustrating various portions of networked computers system 100, in accordance with one embodiment of the present invention, including: user experience sub-system 102; gamer sub-system 104; game application 105; performance manager 107; streamer sub-system 106; supplier sub-systems 108, 110; hardware catalog 111; service provider sub-system 112; videos store 113; communication network 114; promotional strategies computer 200; communication unit 202; processor set 204; input/output (I/O) interface set 206; memory device 208; persistent storage device 210; display device 212; external device set 214; random access memory (RAM) devices 230; cache memory device 232; promotions program 300; performance data store 302; and parameters store 302.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Promotions program 300 operates to determine target performance parameters and corresponding values for a particular computing activity and monitor computing performance during operation of the computing activity. Upon detecting abnormalities in computing performance with respect to target performance parameter values, the promotions program identifies the computing component affecting the performance metric in question and transmitting the performance data including the identified components to a promotional item supplier or service. Promotional materials are received from the contacted supplier or service and presented to the user for improving the user experience by acquiring one or more of the promotional items.

Some embodiments of the present invention recognize the following facts, potential problems and/or potential areas for improvement with respect to the current state of the art: (i) it is important to understand the target audience and their needs when creating promotional materials; (ii) promotional strategies fail to address user experience with using or deploying promotional items; (iii) many networks allow promotions to target materials to users based on the network quality of the audience; and/or (iv) the personal computing (PC) gaming experience relies upon well-performing computing hardware components.

Some embodiments of the present invention are directed to enabling promotional strategies by comparing collected user-experience data to a target user experience. Some embodiments of the present invention surfaces advertisement opportunities based on a target user experience during use of a computing system.

According to some embodiments of the present invention, a target computer gaming experience is defined by certain performance metrics including: (i) processor and graphic card frame rate and/or resolution during game during game play effectively resists image/performance lag; (ii) mouse/cursor movement supports an adequate speed for the type of game being played (i.e. first person play often requires a faster response rate than third person play); and/or (iii) network speed is appropriate for the type of game being played, such as a high performance multiplayer game.

For online gaming in a multiplayer environment, implementation details may include the following operations/infrastructure: (i) the promotional service sits on the computer as a background service; (ii) when a user runs a video game, the promotional service monitors the user experience for predefined experience dimensions or parameters; (iii) a trigger with an associated JSON payload is generated when the user experience is below the standards of a corresponding target user experience.

Some embodiments of the present invention define experience parameters to include: (i) gaming performance: running at a specified frame rate and/or resolution; (ii) network latency during multiplayer game; (iii) network performance during a multiplayer game; (iii) movement of the mouse cursor during a video game.

Some embodiments of the present invention are directed to notifying downstream promotional services responsive to a trigger, processing a JSON payload, and providing targeted promotional materials to the user suggesting, for example: (i) a more GPU having more VRAM than a current configuration (for example, with 256 MB VRAM included); (ii) a wireless network card having improved connectivity over a current network card (or suggesting a wired connection); and/or (iii) a mouse having a higher refresh rate than the currently used mouse.

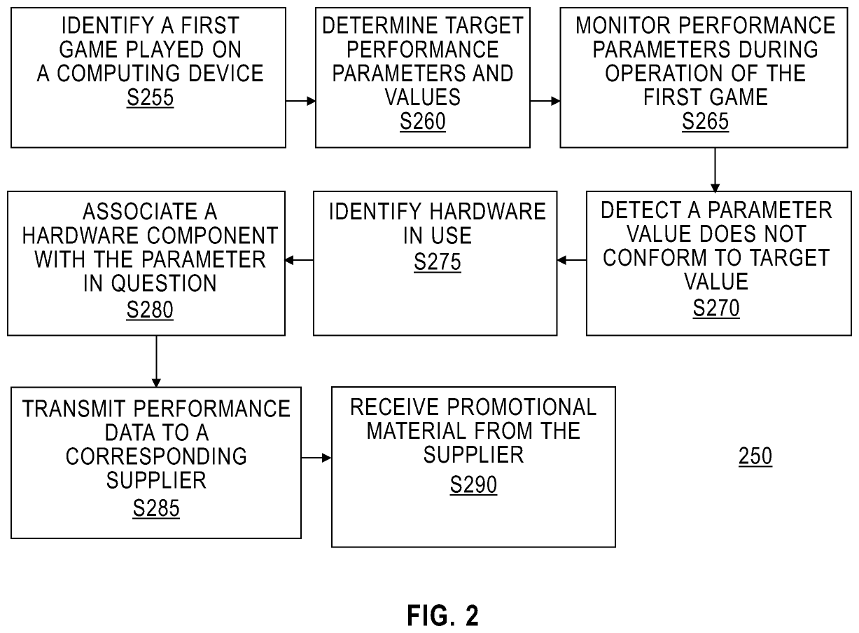

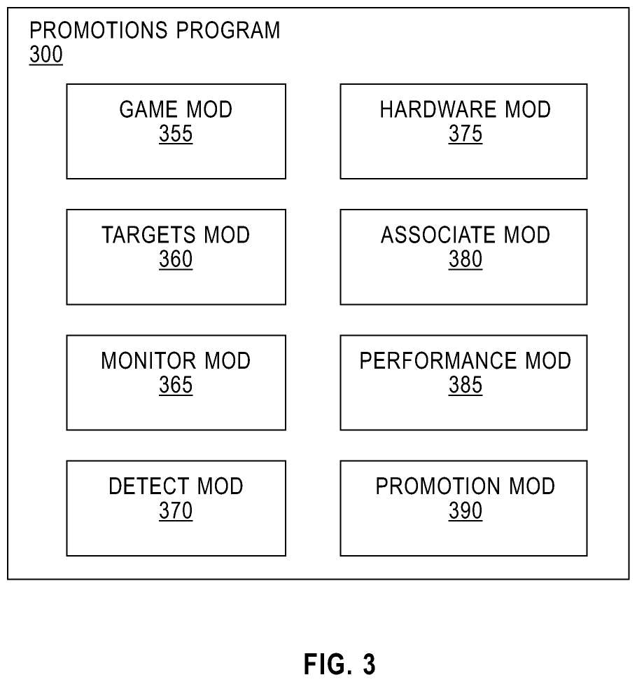

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where game module (“mod”) 355 identifies a first game played on a computing device. In this example, the game mod identifies game 105 played on gamer sub-system 104. While the example disclosed in FIG. 1 illustrates a networked computing system in which computing activity is monitored for performance parameters and supplier, some embodiments of the present invention operate on a single computing device including applications on which computing activity occurs and, in some cases, a set of promotional materials are stored on the device for presenting o the user during operation of the computer upon detecting a user-experience based need. As shown in FIG. 1, alternatives to identifying games being played, some embodiments of the present invention identify streaming events (streamer sub-system 106) or other computational activity performed by a user.

Processing proceeds to step S260, where targets mod 360 determines target performance parameters and target values or value ranges associated with the performance parameters. In this example, performance manager 107 reports targets to the targets module, which stores determined target data in parameters store 302 (FIG. 1). Alternatively, determining target performance includes contacting a supplier or service provider for target performance parameters corresponding to a particular computing activity identified in step S255. Alternatively, target parameters data is pre-defined and stored for access upon identifying the computing activity such as the first game being played in step S255.

Processing proceeds to step S265, where monitor mod 365 monitors performance parameters during operation of the first game on the computing system. During play, the various pre-defined performance parameters are monitored for specific values, which may be stored, for example, in performance data store 302. In some embodiments, a performance manager located on the computing device where the game is being played performs the monitoring activity and may transmit the performance data for evaluation and responsive action. As noted herein, the entire process may occur on a single computer system.

The monitoring activity performed in step S265 further compares actual parameter values with target performance parameter values determined in step S260. The target values are representative of ideal, preferred, or optimal user-experience while performing a computing activity such as playing the first game.

Processing proceeds to step S270, where detect mod 370 detects a parameter value does not conform to a corresponding target value. The parameter value may fall outside of a range of target values. Alternatively, the parameter value exceeds a threshold target value. Alternatively, the parameter value is below a threshold target value. When an actual parameter value is detected during operation of the computer system that does not conform to a corresponding target performance parameter value, a triggering event occurs to generate a proposed resolution to the inferred poor user experience by offering promotional items that may improve the user experience. These steps are outlined in the following steps. Alternatively, the triggering event occurs responsive to a pre-defined number of detected non-conforming parameter values or to a pre-defined number of individual performance parameters that are non-conforming to their corresponding target parameter values. For example, performance parameters store 302 may include a table identifying actionable, or triggering, sets of performance data. In that way, a single performance parameter may be listed as triggering a resolution action while other parameters are required to be paired together such that both parameter values are non-conforming before triggering a resolution action.

Upon triggering a resolution action with non-conforming performance parameter value(s), processing proceeds to step S275, where hardware module 375 identifies hardware in use during operation of the computing activity. Upon detecting the non-conforming parameter value in step S270, the hardware module collects data identifying the various related hardware components supporting performance of the computing activity. The identifying step may include identifying: (i) the video card, (ii) the display device, (iii) the processor, (iv) the mouse; (v) the keyboard; (vi) the joystick; (vii) memory (in response to monitoring for memory usage); (viii) CPU cooler, PC case, fan (in response to monitoring for CPU and overall system temperature); (ix) hard drive (in response to monitoring for read/write performance); (x) network card (in response to monitoring for network performance); (xi) WiFi adapter; (xii) router; and/or (xiii) modem. These identified components are identified as being in use or potentially in use when the triggering non-conforming parameter value(s) is detected.

Processing proceeds to step S280, where associate mod 380 associates a hardware component with the parameter in question. For example, if mouse/cursor activity yields the non-conforming parameter value(s), the hardware module identifies the mouse component being used along with the current mouse driver software. It should be noted that hardware and related software such as drivers may be identified and associated with certain triggering parameter value non-conformances.

Processing proceeds to step S285, where performance mod 385 transmits performance data to a corresponding supplier. Performance data may include: (i) associated hardware/software components; (ii) actual or triggering parameter values; (iii) target parameter values; and/or (iv) computing activity, such as identification of the first game in this example. The corresponding supplier may be identified by cross-reference to the triggering parameter(s) non-conformance in a parameters database such as parameters store 302 (FIG. 1). Alternatively, the associated hardware/software components are entered as a search query, for example on internet search. Suppliers identified by the search results may be cross-referenced with available promotional materials tagged with associated suppliers.

Alternatively, a supplier service is contacted with performance data for generating appropriate promotional materials that correspond with the parameter value non-conformance. For example, performance mod 385 sends performance data to supplier sub-system 110 for analysis with reference to hardware catalog 111 to identify relevant promotional items and materials.

Processing ends at step S275, where promotion mod 390 receives promotional material from the supplier. In this example, promotional materials are accessed at hardware catalog 111 upon identifying the supplier by cross-reference to the triggering parameter(s). Alternatively, the supplier service submits relevant promotional materials to the promotion mod upon analyzing the provided performance data. When promotional materials are received by the promotion mod, the received promotional materials are presented to the user. In some embodiments, the promotional materials are presented by pop-up on the user display device during operation of the computing device. Alternatively, promotional materials are transmitted by email, text, or SMS transmission to a predefined contact means available in a user profile. According to some embodiments of the present invention, in-application purchasing permits the use to purchase promotional items presented to the user by the promotional materials.

According to some embodiments of the present invention, a JSON payload is transmitted upon detecting a parameter value(s) does not conform with a target parameter value(s). The JSON payload may be expressed as follows:

```
{
  ″type″ : ″trigger″,
  ″opportunities″ : {
    ″hardware″ : [
      {
        ″name″ : ″GPU″,
        ″value″ : 10,
        ″description″: ″need more VRAM (128MB)″
      },
      {
        ″name″ : ″Network″,
        ″value″ : 20,
        ″description″: ″need lower latency (200 ms)″
      },
      {
        ″name″ : ″Mouse″,
        ″value″ : 30,
        ″description″: ″need higher accuracy (50hz)″
      }
    ]
  }
}
```

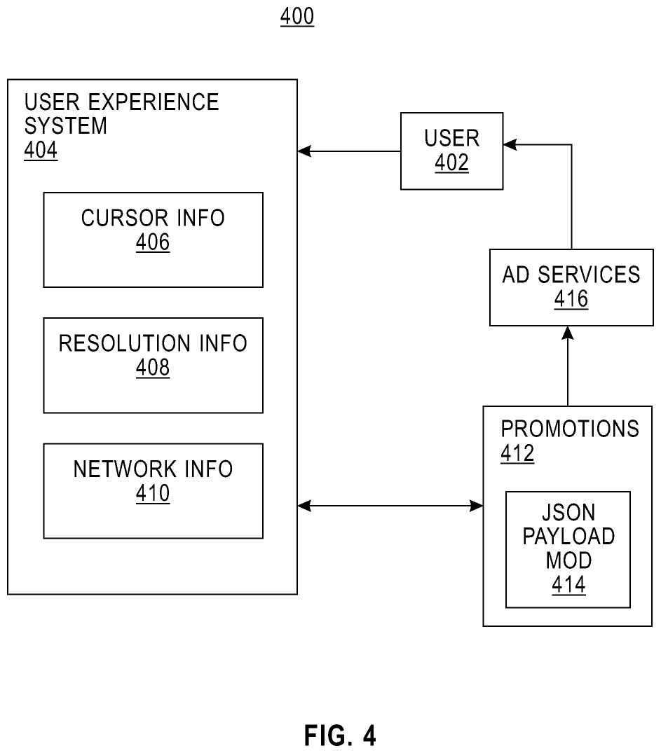

Further embodiments of the present invention are discussed in the paragraphs that follow and later with reference to FIG. 4.

Some embodiments of the present invention are directed to comparing, in real time, the actual and direct experience of a user with a promotional item to a reference experience where the reference experience is a target or ideal experience.

Some embodiments of the present invention are directed to delivering promotional materials on the basis of direct operational experience of a user with a promotional item by comparing, in real time, the actual experience of the user while using the item to a pre-defined ideal experience.

Some embodiments of the present invention are directed to monitoring user activity for gaps between user experience and ideal experience that exceed a predetermined threshold gap and, responsive to exceeding the threshold, triggering a broadcast, allowing downstream services and applications to deliver promotional materials to the user for matching the actual user experience with the ideal experience.

Some embodiments of the present invention are directed to presenting promotional materials to a video game player responsive to in-game computing device performance metrics.

Some embodiments of the present invention gather insights for be shared with downstream services for presenting tailored and/or just-in-time promotional materials to the user. According to some embodiments of the present invention, promotional materials are presented to the user during user based on a current user experience with operating a game or other software on a computer.

Some embodiments of the present invention a directed to surfacing/triggering promotional opportunities based on comparison of actual user experience while operating a computing system with an optimal or target user experience.

According to some embodiments of the present invention, if network quality and/or performance is relatively low, aspects of the present invention determine what constitutes a target user experience based on the needs of the user and application in use. Any deficiency is exposed during use or operation such that promotional items and corresponding promotional materials are presented to overcome the identified deficiency.

Users often fail to enjoy optimal performance under circumstances such as the following: (i) the computing system lags when a game is run at the desired frame rate and resolution (i.e. frame drops, stuttering); (ii) network spikes and/or network latency at a performance level below target for a particular application, such as a multiplayer game; (iii) a user furiously moving a mouse (i.e. sudden increase in acceleration, violent movement) suggesting the user is frustrated about performance of the game, whether hardware or skill-based performance.

FIG. 4 shows system diagram 400 depicting a second system including components for performing a second method according to an embodiment of the present invention. This method and associated components will now be discussed, over the course of the following paragraphs, with extensive reference to FIG. 4. The second method presented herein may be implemented in an individual computing device or in a computer network, such as networked computers system 100 of FIG. 1.

Processing begins where user sub-system 402 provides user activity data to user experience system 404 while the user operates an application running on a computer system.

Processing proceeds to monitoring activity performed by components of the user experience system including cursor information module 406, resolution information module 408, and network information module 410. In this example, the components operate to specifically monitor user activity for performance characteristics with reference to target performance values. Cursor information module 406 operates in part to detect user experience during use of the computing system by evaluating rapid movement of the mouse, clicking frequency of the mouse, and/or comparison to historic mouse usage when operating a particular application. In some examples, the historic usage refers to general use while other example refer to prior use of the particular user in question.

Further monitoring and/or evaluation is performed by resolution information module 408 and network information module 410. The resolution module, in this example, refers to detecting image quality during use of the computing system. Each application may have particular pre-defined performance requirements for optimum user experience. By monitoring actual performance during usage the user experience system is able to detect unsatisfactory conditions experienced by the user. Similarly, network performance is monitored with reference to target or ideal performance parameters.

Processing proceed to promotions system 412 when below threshold performance is detected during monitoring by the user experience system. In this example, any below-threshold performance parameter value triggers processing a JSON payload or otherwise reporting to a promotional services provider of the below-threshold condition. In this example, JSON payload module 414 processes a JSON payload according to the detected below-threshold parameter value. Each parameter is associated with a computer system component for which promotional materials may be provided to user for improving the user experience.

Processing ends when ad services module 416 identifies a promotional item to resolve and/or improve the user experience defined by user experience system and determines appropriate promotional materials to present to the user performing activities on the user sub-system 402. According to some embodiments of the present invention, the had services module accesses a promotional materials store which cross-references user-experience metrics to promotional items. Further user experience system 404 may reference currently existing components deployed in user sub-system so that ad services may recommend component upgrades to the user via promotional materials.

Some embodiments of the present invention are directed to resolving “fat-finger” errors by suggesting a keyboard that is better suited for the user than a currently used keyboard. Accordingly, analysis of performance problems and possible solutions should not be confined to promoting components for only improving a gaming experience but may address many performance issues detected during use of a computing system.

Some embodiments of the present invention do more than selectively insert interactive content into a live television or recorded broadcasting presentation and track the usage of the inserted content by end user viewers of the content. Some embodiments of the present invention do more than enable automated tag processing for media delivered through a mobile platform. Some embodiments of the present invention do more than notify a respective service to process a response by creating promotional materials associated with a respective parameter.

Some embodiments of the present invention do more than attempt delivery of promotional materials based on the manufacturer and/or the model of a device on which a user is engaged. Some embodiments of the present invention do more than attempt delivery of promotional materials based on past user activity, including mouse clicks on a web page and/or digital promotional materials. Some embodiments of the present invention do more than use IoT devices to capture behavioral cues indicating an expressed user interest in content that may be promoted to the user. Some embodiments of the present invention do more than measure performance of a game based on incremental revenue received during the game.

Some embodiments of the present invention do more than apply indirect measures such as pages/sites visited, social likes and follows, purchasing history, social network accounts, browser history, income level, and user hardware to deliver relevant promotional materials.

Some embodiments of the present invention may include one, or more, of the following features, characteristics and/or advantages: (i) provides insights into the needs of a user; and/or (ii) enables promoters to hyper-personalize promotional materials for specific users.

Some embodiments of the present invention are directed to enabling target advertising based on optimal experience of a user including: (i) receiving a first set of values for respective parameters including processor throughput, graphic processor throughput, haptic device response and network response, defining a predetermined optimal online experience associated the user; (ii) monitoring an actual online experience associated the user using at least the respective parameters; (iii) in response to the monitoring, receiving a second set of values for the respective parameters in real time, defining the actual online experience associated the user; (iv) comparing the first set of values with the second set of values in real time; (v) in response to a determination at least one of the second set of values differs by a predetermined threshold variance from a corresponding one of the first set of values, triggering a response associated with a respective parameter indicating a suggested solution; and (vi) notifying a respective service listening for the response to process the response to create the target advertising associated with the respective parameter and the suggested solution.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
detecting a start of a computing activity performed by a user;
determining an activity type according to the detected computing activity;
responsive to determining the activity type, identifying, in a database, a set of target performance parameters for the activity type, the set of target performance parameters related to computer performance during the computing activity;
monitoring the computing activity performed by the user for a set of performance parameters associated with user-experience during performance of the activity type, the set of performance parameters including network speed and graphic card frame rate;
comparing actual values of the set of performance parameters with corresponding target values of the set of target performance parameters;
responsive to identifying a first performance parameter value not conforming to a corresponding first target parameter value, determining a set of computer hardware components effecting the first performance parameter value;
processing a JSON payload corresponding to the set of computer hardware components, the JSON payload including actual values of the set of performance parameters;
analyzing the JSON payload to identify a promotional item to change the set of computer hardware components to a second set of computer hardware components including the promotional item;
identifying promotional material describing an upgrade to the second the set of computer hardware components; and
presenting to the user the promotional material;
wherein:
including the promotional item is pre-defined as resulting in an acceptable user experience while performing the activity type.

2. (canceled)

3. The computer-implemented method of claim 1, further comprising:
determining threshold values for the set of performance parameters including the corresponding target parameter value, the threshold values being pre-defined as representative of an acceptable user experience while performing the determined activity type.

4. (canceled)

5. The computer-implemented method of claim 4, further comprising:
identifying computer hardware components used for performing the computing activity including the set of computer hardware components.

6. (canceled)

7. A computer program product comprising a computer-readable storage medium having a set of instructions stored therein which, when executed by a processor, causes the processor to perform a method comprising:
detecting a start of a computing activity performed by a user;
determining an activity type according to the detected computing activity;
responsive to determining the activity type, identifying, in a database, a set of target performance parameters for the activity type, the set of target performance parameters related to computer performance during the computing activity;
monitoring a computing activity performed by the user for a set of performance parameters associated with user-experience during performance of the activity type, the set of performance parameters including network speed and graphic card frame rate;
comparing actual values of the set of performance parameters with corresponding target values of the set of target performance parameters;
responsive to a first performance parameter value not conforming to a corresponding first target parameter value, determining a set of computer components effecting the first performance parameter value;
processing a JSON payload corresponding to the set of computer hardware components, the JSON payload including actual values of the set of performance parameters;
analyzing the JSON payload to identify a promotional item to change the set of computer hardware components to a second set of computer hardware components including the promotional item;
identifying promotional material describing an upgrade to the second set of computer hardware components; and
presenting to the user the promotional material;
wherein:
including the promotional item is pre-defined as resulting in an acceptable user experience while performing the activity type.

8. (canceled)

9. The computer program product of claim 7, further causing the processor to perform a method comprising:
determining threshold values for the set of performance parameters including the corresponding target parameter value, the threshold values being pre-defined as representative of an acceptable user experience while performing the computing activity.

10. (canceled)

11. The computer program product of claim 10, further causing the processor to perform a method comprising:
identifying computer hardware components used for performing the computing activity including the set of computer hardware components.

12. (canceled)

13. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
detecting a start of a computing activity performed by a user;
determining an activity type according to the detected computing activity;
responsive to determining the activity type, identifying, in a database, a set of target performance parameters for the activity type, the set of target performance parameters related to computer performance during the computing activity;
monitoring a computing activity performed by the user for a set of performance parameters associated with user-experience during performance of the activity type, the set of performance parameters including network speed and graphic card frame rate;
comparing actual values of the set of performance parameters with corresponding target values of the set of target performance parameters;
responsive to a first performance parameter value not conforming to a corresponding first target parameter value, determining a set of computer components effecting the first performance parameter value;
processing a JSON payload corresponding to the set of computer hardware components, the JSON payload including actual values of the set of performance parameters;
analyzing the JSON payload to identify a promotional item to change the set of computer hardware components to a second set of computer hardware components including the promotional item;
identifying promotional material describing an upgrade to the second set of computer hardware components; and
presenting to the user the promotional material;
wherein:
including the promotional item is pre-defined as resulting in an acceptable user experience while performing the activity type.

14. (canceled)

15. The computer system of claim 13, further causing the processor to perform a method comprising:
determining threshold values for the set of performance parameters including the corresponding target parameter value, the threshold values being pre-defined as representative of an acceptable user experience while performing the computing activity.

16. (canceled)

17. The computer system of claim 13, further causing the processor to perform a method comprising:
identifying computer hardware components used for performing the computing activity including the set of computer hardware components.

18. (canceled)

19. The computer-implemented method of claim 1, wherein the set of computing hardware components includes a keyboard.
